(19) United States
(12) Patent Application Publication
(10) Pub. No.: US 2010/0136430 A1
(43) Pub. Date: Jun. 3, 2010

(54) NCM POSITIVE ACTIVE MATERIAL FOR SECONDARY BATTERY AND SECONDARY BATTERY INCLUDING THE SAME

(76) Inventor: Youngwoo Lee, Yongin-si (KR)

Correspondence Address: CHRISTIE, PARKER & HALE, LLP, PO BOX 7068, PASADENA, CA, 91109-7068, US

(21) Appl. No.: 12/623,012

(22) Filed: Nov. 20, 2009

(30) Foreign Application Priority Data
Dec. 2, 2008 (KR) 10-2008-0121516

(51) Int. Cl. H01M 4/00; H01B 1/04

(52) U.S. Cl. 429/223; 252/503

(57) ABSTRACT

An NCM positive active material composition and a secondary battery including the same are disclosed. The NCM positive active material composition has a good conductivity and increased capacity, and is prepared by utilizing a high density mixture. The NCM positive active material composition includes an NCM positive active material, a conductive agent, and a binder, and the conductive agent contains graphite.

### CROSS-REFERENCE TO RELATED PATENT APPLICATION

This application claims priority to and the benefit of Korean Patent Application No. 10-2008-0121516, filed on Dec. 2, 2008, in the Korean Intellectual Property Office (KIPO), the entire content of which is incorporated herein by reference.

### BACKGROUND OF THE INVENTION

1. Field of the Invention

The present invention relates to a NiCoMn (herein below, abbreviated to NCM) positive active material for a secondary battery.

2. Description of the Related Art

In general, a secondary battery is composed of a positive electrode, a negative electrode, a non-aqueous electrolyte, and a separator disposed between the positive electrode and the negative electrode. The positive electrode is usually prepared by the application of a mixture of a positive active material, an electric conductor, and a binder applied to the positive electrode collector. The LiCoO₂ is largely used as a positive active material. The LiCoO₂ has stable charge-discharge properties, good conductivity, good stability, and flat discharge voltage characteristics. However, there is a need for the development of another positive active material because cobalt is an expensive material due to a scarcity of natural deposits and because cobalt is toxic to humans.

One alternative material for LiCoO₂ is a lithium composite metal oxide, Li[NiₓCO_{1-x-y}Mn_{y}]O₂ (where 0<x<0.5, 0<y<0.5) which has a layered crystal structure. The lithium composite metal oxide is obtained by mixing and plastic working with lithium hydroxide and a precursor which is prepared from the simultaneous precipitation of three elements by a neutralization reaction in an aqueous solution. The precursor has an oxide or a hydroxide form. This NCM positive active material, however, does not meet the requirements of a secondary battery that demands high energy and capacity.

In addition, a small amount of carbon black having a good conductivity is used as a conductive agent for a positive active material. However, carbon black reduces density of a positive active material mixture because dispersion of carbon black is not homogeneous in the positive active material mixture. As such, the development of a high density mixture is limited because of the low density caused by the carbon black dispersion.

### SUMMARY OF THE INVENTION

An aspect of an embodiment of the present invention is directed toward an improved NCM positive active material composition for a secondary battery having high conductivity and high capacity, the improved NCM positive active material including an NCM positive active material with a high density mixture.

Another aspect of an embodiment of the present invention is directed toward a secondary battery including a positive electrode containing the improved NCM positive active material composition.

In accordance with an exemplary embodiment of the present invention, there is provided an NCM positive active material composition including graphite as a conductive agent which can be mixed with an NCM positive active material and a binder.

In accordance with another exemplary embodiment of the present invention, there is provided a secondary battery including a positive electrode containing the NCM positive active material composition including the graphite, a negative electrode, and a separator disposed between the positive electrode and negative electrode.

As such, the NCM positive active material composition shows good conductance and can be used to obtain a high density mixture by the substitution of a portion of a conductive agent with graphite such that smaller amounts of binder and larger amounts of NCM positive active material can be used. The high content of the NCM positive active material through the low usage of the binder increases the capacity of the secondary battery. As a result, the secondary battery including the positive electrode prepared by embodiments of the present invention has an increased capacity and good conductance.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view of a secondary battery according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

Hereinafter, exemplary embodiments of the present invention are described in more detail.

An NCM positive active material composition according to an embodiment of the present invention includes an NCM positive active material, a conductive agent, and a binder. The conductive agent includes graphite.

An NCM positive active material is any suitable NCM positive active material used in a lithium ion secondary battery. As an example, a lithium composite metal oxide, Li[NiₓCO_{1-x-y}Mn_{y}]O₂ type (where 0<x<0.5, 0<y<0.5) is used, but the present invention is not limited to this type of positive active material.

According to an embodiment of the present invention, a conductive agent includes a graphite which can be utilized to prepare a high density mixture with an NCM positive active material and to increase the capacity of a battery such that smaller amounts of binder and larger amounts of NCM positive active material can be used.

In one embodiment, the amount of graphite is between about 0.5 and about 50 weight percent with respect to the total amount of the conductive agent. That is, in one embodiment, it is difficult to make a high density mixture and increase the capacity of a battery when the used amount of graphite is less than 0.5 weight percent with respect to the total amount of the conductive agent. In another embodiment, although it is possible to make a high density mixture when the used amount of graphite is more than 50 weight percent with respect to the total amount of the conductive agent, the conductance of the mixture decreases when the used amount of graphite is more than 50 weight percent with respect to the total amount of the conductive agent. Therefore, in one embodiment of the present invention, the amount of graphite is between 0.5 and 50 weight percent with respect to the total amount of the conductive agent.

In one embodiment, an average diameter of graphite is between about 1 and about 10 micrometers. That is, in one embodiment, graphite having an average diameter larger than 10 micrometers decreases conductance because a bridge role of graphite between the active materials is not sufficiently performed. In another embodiment, it is difficult to prepare a mixture by the use of graphite having an average diameter smaller than 1 micrometer. Thus, in one embodiment of the present invention, an average diameter of graphite is between 1 and 10 micrometers.

Also, in one embodiment, the graphite utilized is synthetic graphite and/or crystalline graphite, such as SFG-6 (Timcal Co.) or KPL3-1 (Kansai Netsu Kagaku, Japan), which has a small diameter and good conductance.

Another conductive agent, besides graphite, which has conductance without a chemical change to the cell can be used for an embodiment of the present invention. For example, the conductive agent can be carbon black, such as acetylene black, ketjen black, channel black, furnace black, lamp black, and thermal black; conducting fiber, such as carbon fiber and metal fiber; metal powder, such as aluminum, nickel, and fluorinated carbon; conducting material, such as zinc oxide and potassium titanate; conducting metal oxide, such as titanium oxide; and/or organic conducting material, such as polyphenylene derivatives.

The above conductive agents can be added to the positive active material. The conductive agent content is between 1 to 10 weight percent with respect to the total amount of the positive active material.

In one embodiment, a binder is added to give adhesive strength. The amount of the binder to be used in the positive active material composition is within any suitable range of use. The binder can be polyvinyl alcohol, carboxy methyl cellulose, hydroxy propylene cellulose, diacetylene cellulose, polyvinyl chloride, polyvinyl pyrrolidone, polytetrafluoroethylene, polyvinylidene fluoride, polyethylene, or polypropylene. However, the binder of the present invention is not limited to the above materials.

The NCM positive active material composition according to an embodiment of the present invention includes an NCM positive active material, a conductive agent, and a binder. If desired or needed, an additive can be added in the process of the preparation of the positive active material without alteration of the characteristics of the present invention.

In one embodiment of the present invention, the NCM positive active material composition includes an NCM positive active material of 96.5 weight percent, a conductive agent of 2 weight percent, and a binder of 1.5 weight percent. The amount of graphite is 25 weight percent of the conductive agent. This composition gives good characteristics such as high conductance, high capacity, and a high density mix.

An embodiment of the present invention provides a secondary battery which has a positive electrode containing an NCM positive active material composition, a negative electrode, a non-aqueous electrolyte, and a separator disposed between a positive electrode and a negative electrode.

A positive electrode is made by a conventional preparation method of a positive electrode. Slurry of NCM positive active material composition according to the present invention is prepared. The slurry is applied on a positive electrode collector, and then dried.

In one embodiment, the thickness of a positive electrode collector is between 10 and 500 micrometers. However, a positive electrode collector of the present invention is not limited to a described positive electrode collector and may be formed by any suitable material and/or to any suitable thickness, which has good conductance without causing a chemical change in the battery. For example, the material can be stainless steel, aluminum, nickel, titanium, or elastic carbon; or aluminum or stainless steel treated with carbon, nickel, titanium, or silver on the surface. In one embodiment, minute unevenness formed on the surface of a positive electrode collector is utilized to increase adhesive strength of a positive active material. The form of a positive electrode collector is a film, a sheet, a foil, a net, porous, a foam, or a non-woven fabric.

A negative electrode can be made by any suitable preparation method of a negative electrode of a lithium secondary battery. In one embodiment, slurry composed of a negative active material, a binder, and a conductive agent is applied on an electric or a negative electrode collector, and then dried.

The above negative active material can be any compound in which reversible intercalation and deintercalation of lithium ions is possible. An example of a negative active material is artificial graphite, synthetic graphite, graphitized carbon fiber, or amorphous carbon. Another example of a negative active material is a metal to be alloyed with lithium or a composite containing metal and carbon. A metal which can be alloyed with lithium is silicon, aluminum, tin, lead, zinc, bismuth, indium, magnesium, gallium, cadmium, silicon alloy, tin alloy, or aluminum alloy. In addition, a thin film of metallic lithium can also be used as a negative active material.

Any suitable binder and any suitable conductive agent can be used. For example, the above conductive agent and the binder in the above described positive active material composition can be used.

In one embodiment, the thickness of a negative electrode collector is between 5 and 500 micrometers. However, a negative electrode collector is not limited to a described negative electrode collector and may be formed by any suitable material and/or to any suitable thickness, which has good conductance without causing a chemical change in the battery. For example, the material can be copper, stainless steel, aluminum, nickel, titanium, elastic carbon, aluminum-cadmium alloy; or copper or stainless steel in which its surface is treated with carbon, nickel, titanium, or silver. In one embodiment, minute unevenness formed on the surface of a negative electrode collector is utilized to increase adhesive strength of a negative active material. The form of a negative electrode collector can be a film, a sheet, a foil, a net, porous, a foam, or a non-woven fabric.

A thin insulating separator which has a high ion permeation ability and high mechanical strength is disposed between the above positive electrode and negative electrode. In one embodiment, the separator is composed of polyethylene, polypropylene, or polyvinylidene fluoride. In one embodiment, a multi layer separator which has more than two separator layers can be used. In one embodiment, the multi layer separator is a polyethylene/polypropylene double layer separator, a polyethylene/polypropylene/polyethylene triple layer separator, or a polypropylene/polyethylene/polypropylene triple layer separator.

The electrolyte for the above lithium secondary battery may be any suitable non-aqueous electrolyte which is used for the manufacturing of a lithium secondary battery. In one embodiment, the non-aqueous electrolyte is composed of non-aqueous organic solvents and a lithium salt.

The above non-aqueous organic solvent serves as a medium in which ions involved in an electrochemical reaction of a battery can move. Here, the organic solvent can be selected from suitable solvents for secondary batteries.

In one embodiment, the solvent is one or a mixture of non-aqueous organic solvents selected from the group consisting of a cyclic carbonate, a non-cyclic carbonate, fatty acid ester, a non-cyclic ether, a cyclic ether, or alkyl phosphate ester, or its fluorinated compound.

The above cyclic carbonate is ethylene carbonate, propylene carbonate, butylenes carbonate, or vinylene carbonate. The non-cyclic carbonate is dimethyl carbonate, diethyl carbonate, ethylmethyl carbonate, methylpropyl carbonate, ethylpropyl carbonate, dipropyl carbonate, or methyl ethyl carbonate. The fatty acid carboxylate is methyl formate, methyl acetate, methyl propionate, or ethyl propionate. The non-cyclic ether is gamma-lactone, 1,2-dimethoxy ethane, 1,2-diethoxy ethane, 1,2-diethoxy ethane, or ethoxymethoxy ethane. The cyclic ether is tetrahydrofuran or 2-methylhydrofuran. The alkyl phosphate is dimethyl sulfoxide, 1,2-dioxolane, trimethyl phosphate, triethyl phosphate, or trioctyl phosphate.

A lithium salt contained in the above non-aqueous electrolyte is the source of lithium ions in a battery and is a key component in operation of a battery. A lithium salt can be selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and LiI.

In one embodiment, the concentration of the above lithium salt is between 0.6 and 2.0 M, and more preferably, 0.7 and 1.6 M. That is, in one embodiment, the performance of an electrolyte is decreased due to low conductance of an electrolyte when the concentration of an electrolyte is below 0.6 M. In another embodiment, when the concentration of an electrolyte is above 2.0 M, the mobility of lithium ions is decreased.

Other suitable additives which may be used for the preparation of a secondary battery can be added to the non-aqueous electrolyte without interfering with effects of the present invention.

A separator is disposed between a positive electrode and a negative electrode prepared by the above methods, and then inserted into a cell. An electrolyte is injected to the cell to make a battery assembly. This lithium secondary battery composed of an electrolyte, a positive electrode, and a negative electrode is a unit cell having a structure of positive electrode/separator/negative electrode, a bicell having a structure of positive electrode/separator/negative electrode/separator/positive electrode, or a layered cell having a structure of a stack of unit cells.

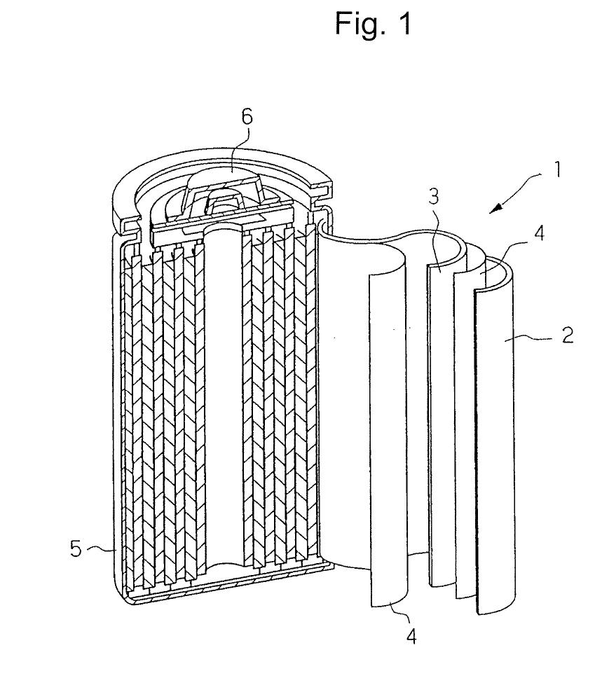

In an embodiment of the present invention, a secondary battery 1 is provided which includes a positive electrode 3 composed of an improved NCM positive active material as described above. As shown in FIG. 1, the secondary battery 1 includes a negative electrode 2, the positive electrode 3, and a separator 4 positioned between the negative electrode 2 and the positive electrode 3. The negative electrode 2, the positive electrode 3, and the separator 4 are wound together to form an electrode assembly. The electrode assembly is enclosed within a battery case 5 with an electrolyte, and is sealed with a cap assembly 6.

### EXAMPLES

Hereinafter, the present invention will be described in more detail with reference to the following examples. These examples are provided for illustrating the present invention and should not be construed as limiting the scope and spirit of the present invention.

### Example 1

### Manufacturing of a Positive Active Material Composition

Lithium composite metal oxide Li[Ni_{0.333}CO_{0.334}Mn_{0.333}]O₂ of 96.5 weight percent (as an NCM positive active material), polyvinylidene fluoride (PVFD) of 1.5 weight percent (as a binder), and carbon black of 1.5 weight percent and graphite granules (SFG-6, TimCal) of 0.5 weight percent (as a conductive agent) are mixed to prepare a positive active material composition. The average diameter of graphite is 6 micrometers.

### Example 2

### Manufacturing of a Positive Active Material Composition

Lithium composite metal oxide Li[Ni_{0.333}CO_{0.334}Mn_{0.333}]O₂ of 96.5 weight percent (as an NCM positive active material), polyvinylidene fluoride (PVFD) of 1.5 weight percent (as a binder), and carbon black of 1.0 weight percent and graphite granules (SFG-6, TimCal) of 1.0 weight percent (as a conductive agent) are mixed to prepare a positive active material composition. The average diameter of graphite is 6 micrometers.

### Example 3

### Manufacturing of a Positive Active Material Composition

Lithium composite metal oxide Li[Ni_{0.333}CO_{0.334}Mn_{0.333}]O₂ of 96.5 weight percent (as an NCM positive active material), polyvinylidene fluoride (PVFD) of 1.5 weight percent (as a binder), and carbon black of 1.9 weight percent and graphite granules (SFG-6, TimCal) of 0.1 weight percent (as a conductive agent) are mixed to prepare a positive active material composition. The average diameter of graphite is 6 micrometers.

### Comparative Example 1

Lithium composite metal oxide Li[Ni_{0.333}CO_{0.334}Mn_{0.333}]O₂ of 96 weight percent (as an NCM positive active material), polyvinylidene fluoride (PVFD) of 2 weight percent (as a binder), and carbon black of 2 weight percent (as a conductive agent) are mixed to prepare a positive active material composition.

### Comparative Example 2

Lithium composite metal oxide Li[Ni_{0.333}CO_{0.334}Mn_{0.333}]O₂ of 96.5 weight percent (as an NCM positive active material), polyvinylidene fluoride (PVFD) of 1.5 weight percent (as a binder), carbon black of 0.5 weight percent and graphite granules (SFG-6, TimCal) of 1.5 weight percent (as a conductive agent) are mixed to prepare a positive active material composition. The average diameter of graphite is 6 micrometers.

### Manufacturing of a Battery

A positive electrode is formed as follows. The surface of an aluminum foil having a thickness of 15 micrometers is uniformly coated with the positive active material which is prepared according to the above example 1, example 2, example 3, comparative example 1, or comparative example 2. The aluminum foil cast by doctor blading to have a gap size of 250 micrometers is placed in an oven at 110 degrees Celsius and for 12 hours to evaporate NMP. After that, it is compression-molded by a roller pressing machine, thereby a positive electrode having a thickness of 95 micrometers is manufactured.

Separately, graphite powder of 96 weight percent and PVDF of 4 weight percent as a binder are mixed together, and then kneaded for 10 hours with ceramic balls. The surface of the copper foil having a thickness of 19 micrometers is uniformly coated with the above negative active material. The copper foil cast by a doctor blade having a gap size of 300 micrometers is dried in an oven at 90 degrees Celsius and for 10 hours. After that, they are compression-molded by a roller pressing machine, thereby a negative electrode having a thickness of 120 micrometers is manufactured.

A polyethylene/polypropylene porous membrane (Hoechst Cellanese Co.) having a thickness of 20 micrometers is used as a separator. The separator is disposed between a positive electrode and a negative electrode. A battery assembly is formed by winding the above laminated body into a spiral shape for a number of times. The battery assembly is enclosed in a polygonal battery can made of aluminum. A non-aqueous electrolyte is injected into the battery can and then sealed. The manufactured lithium secondary battery has a capacity of 820 mAh and a thickness of 4.5 mm. The amount of a non-aqueous electrolyte is 2.7 g. The non-aqueous electrolyte is prepared by mixing ethylene carbonate of 30 volume percent containing LiPF₆ of 1.1 M, ethylmethyl carbonate of 55 volume percent, propylene carbonate of 5 volume percent, and fluoro benzene of 10 volume percent.

### Experiment 1

The results of the charge-discharge characteristics and the measurement of conductance of the unit cell manufactured by the above method are shown in Table 1. After repeated charge-discharge of the manufactured battery with 4.2 V at 0.2 C, the charge-discharge characteristics are measured by the discharge capacity according to C-rate.

### Experiment 2

A positive active material prepared according to the above example 1, example 2, example 3, comparative example 1, or comparative example 2 is pressed into a pellet at a pressure of a 2.5 tons. Table 2 shows measurement results of the pellet density of positive active materials.

TABLE 1

| | | Capacity/g | | Pellet |
|---|---|---|---|---|
| | Conductive | (0.2 C | Conductivity | density |
| | agent | discharge) | (S/cm) | (2.5 t/cm²) |
| Example 1 | Carbon black | 159.8 | 1.48E−0.3 | 3.31 |
| | of 1.5 wt % + | | | |
| | graphite of | | | |
| | 0.5 wt % | | | |
| Example 2 | Carbon black | 159.9 | 1.51E−03 | 3.29 |
| | of 1.0 wt % + | | | |
| | graphite of | | | |
| | 1.0 wt % | | | |
| Example 3 | Carbon black | 159.6 | 1.41E−03 | 3.26 |
| | of 1.9 wt % + | | | |
| | graphite of | | | |
| | 0.1 wt % | | | |
| Comparative | Carbon black | 159.3 | 1.32E−03 | 3.20 |
| Example 1 | of 2.0 wt % | | | |
| Comparative | Carbon black | 159.9 | 1.39E−0.3 | 3.27 |
| Example 2 | of 0.5 wt % + | | | |
| | graphite of | | | |
| | 1.5 wt % | | | |

As shown in Table 1, it is confirmed that by the addition of graphite into a conductive agent according to examples 1, 2, and 3, the density of the mixture, conductance, and capacity are improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An NCM positive active material composition comprising:
an NCM positive active material;
a conductive agent; and
a binder,
wherein the conductive agent comprises graphite.

2. The NCM positive active material composition according to claim 1, wherein the graphite is between about 0.5 weight percent and about 50 weight percent with respect to a total amount of the conductive agent.

3. The NCM positive active material composition according to claim 1, wherein the conductive agent is between about 1 weight percent and about 10 weight percent with respect to a total amount of the NCM positive active material composition.

4. The NCM positive active material composition according to claim 1, wherein the graphite has an average diameter between about 1 and about 10 micrometers.

5. The NCM positive active material composition according to claim 1, wherein the graphite is selected from the group consisting of synthetic graphite, crystalline graphite, and combinations thereof.

6. The NCM positive active material composition according to claim 1, wherein the conductive agent is selected from the group consisting of carbon black, acetylene black, ketjen black, channel black, furnace black, lamp black, thermal black, carbon fiber, metal fiber, fluorinated carbon, aluminum, nickel powder, zinc oxide, potassium titanate, titanium oxide, polyphenylene derivatives, and combinations thereof.

7. The NCM positive active material composition according to claim 1, wherein the NCM positive active material is a Li[NiₓCO_{1-x-y}Mn_{y}]O₂ active material, and wherein x is between 0 and 0.5 and y is between 0 and 0.5.

8. The NCM positive active material composition according to claim 1, wherein the NCM positive active material is about 96.5 weight percent, the conductive agent is about 2 weight percent, and the binder is about 1.5 weight percent with respect to a total amount of the NCM positive active material composition.

9. The NCM positive active material composition according to claim 8, wherein the graphite is about 25 weight percent with respect to a total amount of the conductive agent.

10. A secondary battery comprising:
a positive electrode comprising an NCM positive active material composition;
a negative electrode;
a non-aqueous electrolyte; and
a separator between the positive electrode and the negative electrode,
wherein the NCM positive active material composition comprises:
an NCM positive active material;
a conductive agent; and
a binder, and
wherein the conductive agent comprises graphite.

11. The secondary battery according to claim 10, wherein the graphite is between about 0.5 weight percent and about 50 weight percent with respect to a total amount of the conductive agent.

12. The secondary battery according to claim 10, wherein the conductive agent is between about 1 weight percent and about 10 weight percent with respect to a total amount of the NCM positive active material.

13. The secondary battery according to claim 10, wherein the graphite has an average diameter between about 1 and about 10 micrometers.

14. The secondary battery according to claim 10, wherein the graphite is selected from the group consisting of synthetic graphite, crystalline graphite, and combinations thereof.

15. The secondary battery according to claim 10, wherein the conductive agent is selected from the group consisting of carbon black, acetylene black, ketjen black, channel black, furnace black, lamp black, thermal black, carbon fiber, metal fiber, fluorinated carbon, aluminum, nickel powder, zinc oxide, potassium titanate, titanium oxide, polyphenylene derivatives, and combinations thereof.

16. The secondary battery according to claim 10, wherein the NCM positive active material is a Li[NiₓCO_{1-x-y}Mn_{y}]O₂ active material, and wherein x is between 0 and 0.5 and y is between 0 and 0.5.

17. The secondary battery according to claim 10, wherein the NCM positive active material is about 96.5 weight percent, the conductive agent is about 2 weight percent, and the binder is about 1.5 weight percent with respect to a total amount of the NCM positive active material composition.

18. The secondary battery according to claim 17, wherein the graphite is about 25 weight percent with respect to a total amount of the conductive agent.
